(19) United States
(12) Patent Application Publication
(10) Pub. No.: US 2004/0116016 A1
(43) Pub. Date: Jun. 17, 2004

(54) Method for the addition of anti-microbial compounds to fiberglas insulation products

(76) Inventors: Yadollah Delaviz, Granville, OH (US); Kevin S. Guigley, Granville, OH (US); Liang Chen, New Albany, OH (US)

Correspondence Address: OWENS CORNING, 2790 COLUMBUS ROAD, GRANVILLE, OH, 43023, US

(21) Appl. No.: 10/319,154

(22) Filed: Dec. 13, 2002

(51) Int. Cl. B32B 27/04; B32B 27/12

(52) U.S. Cl. 442/123; 65/451

(57) ABSTRACT

A method of inhibiting the growth of microorganisms such as bacteria, fungi, and molds in fiberglass products by adding an anti-microbial to a binder solution to impregnate glass fibers with the anti-microbial in-line during the manufacturing process and before the curing process is provided. Suitable examples of the anti-microbial include zinc 2-pyrimidinethiol-1-oxide, 1-[2-(3,5-Dichloro-phenyl)-4-propyl-[1,3]dioxolan-2-ylmethyl]-1H-[1,2,4]triazole, 4,5-Dichloro-2-octyl-isothiazolidin-3-one, 2-Octyl-isothiazolidin-3-one, 5-Chloro-2-(2,4-dichloro-phenoxy)-phenol, 2-Thiazol-4-yl-1H-benzoimidazole, 1-(4-Chloro-phenyl)-4,4-dimethyl-3-[1,2,4]triazol-4-ylmethyl-pentan-3-ol, 10, 10′ Oxybisphenoxarsine, 1-(Diiodo-methanesulfonyl)-4-methyl-benzene and mixtures thereof. The fiberglass product formed by the method of the present invention is substantially free of bacteria, fungi, and molds.

### TECHNICAL FIELD AND INDUSTRIAL APPLICABILITY OF THE INVENTION

The present invention relates generally to the inhibition of microorganisms, and more particularly to a method for the inhibition of bacteria, fungi, and mold on fiberglass insulation products.

### BACKGROUND OF THE INVENTION

Bacteria, fungi, viruses, and other microorganisms are present throughout the environment. The species and numbers of microorganisms present in any situation depends on the general environment, the nutrients present, the amount of moisture available for the microorganisms, and on humidity and temperature of the environment. Microorganisms are an essential part of ecological systems, industrial processes, and healthy human and animal functions, such as digestion. In other situations, however, the presence of microorganisms is highly undesirable because they can cause create odors, damage, or destroy a wide variety of materials.

One such situation where the presence of microorganisms is detrimental is in fiberglass insulation products. When water, dust, and other microbial nutrients contaminate fiberglass products, these contaminates provides a support medium for the growth of bacteria, fungi, and/or mold in and on the products. This bacterial, fungal, and mold growth causes odor, discoloration, and product deterioration. In addition, the generation of such microorganisms can create problems in the manufacturing process itself, such as by plugging the filters used to filter wash water in the manufacturing process. In general, mold and bacterial growth in the wash water is a major problem in fiberglass manufacturing in terms of processing and product quality.

Many types of anti-microbials have been applied to fibrous substrates to protect articles formed from such compositions against such microbial degradation. A wide variety of chemical compounds, differing in chemical structure, mechanism of activity, and preferred mode of application are useful as anti-microbials to kill a wide variety of harmful, destructive, or offensive microorganisms including viruses, bacteria, algae, yeasts, and molds. These anti-microbials are conventionally applied to the product, regardless of whether the product is a metal, fiberglass, or plastic media, by spraying, misting, or painting the anti-microbial on the media, such as is taught, for example, in U.S. Pat. Nos. 5,066,328, 5,487,412, 5,939,203, and 5,474,739.

For example, some insulation products, such as duct liners, have conventionally spray coated an anti-microbial onto the duct liner to protect the top surface that is exposed to the moving air in a duct. Unlike with fiberglass insulation, in a duct liner, other surfaces are not easily accessible. For example, the bottom surface of the duct liner is only exposed to the metal of the duct and the sides are only exposed to neighboring products. In addition, the duct liner typically has a high-density surface, which means that there is a large number of fibers and binder at the top surface. If dust and/or dirt accumulates on the duct liner surface, it is only on the very top where mold growth might occur. Thus, to help enhance the mold resistance, conventional systems spray or roll coat an anti-microbial onto the top surface.

However, no method heretofore has been known to add an anti-microbial to a binder solution to impregnate glass fibers with the anti-microbial in-line during the manufacturing process of fiberglass products before the curing process.

### SUMMARY OF THE INVENTION

Accordingly, an important object of the present invention is to provide a method for inhibiting the growth of microorganisms in glass fiber insulation products that overcomes the disadvantages of the prior art.

It is another object of the present invention to add a anti-microbial to a binder solution to impregnate glass fibers with the anti-microbial in-line during the manufacturing process before the curing process.

It is another object of the present invention to add an anti-microbial to a binder solution to deposit an anti-microbial along the length of glass fibers in-line during the manufacturing process before the curing process.

It is an advantage that the selected anti-microbials are compatible with these binders in the production process of fiberglass products.

It is an advantage of the present invention that the formed fiberglass products are substantially free of microorganisms.

It is another advantage of the invention that the anti-microbial is added in-line in the manufacturing process such that no additional processing steps are needed.

These and other objects, features, and advantages are accomplished according to the present invention by providing a method for inhibiting the growth of microorganisms in fiberglass insulation products that adds an anti-microbial to a binder solution to impregnate glass fibers with the anti-microbial in-line during the manufacturing process before the curing process.

The foregoing and other objects, features, and advantages of the invention will appear more fully hereinafter from a consideration of the detailed description that follows.

### DETAILED DESCRIPTION AND PREFERRED EMBODIMENTS OF THE INVENTION

The present invention solves the aforementioned disadvantages and problems of the prior art by providing a method for inhibiting the growth of microorganisms in fiberglass insulation products that adds a anti-microbial to a binder solution to impregnate glass fibers with the anti-microbial in-line during the manufacturing process before the curing process.

In a conventional method of manufacturing fiberglass products, glass fibers are formed by flowing molten glass through small tubular openings of a spinner at a high rate of rotation. These fibers are blown down towards a collection belt. While the fibers are failing, binder solution is sprayed towards the veil of glass fibers, which adds the binder solution to the glass fibers. The collection of glass fibers and binder solution is then heated in an oven where the binder cures, typically at a high temperature, preferably from 350-550° F. This cured binder adheres to the glass fibers and this binding is responsible for most of properties of the fiberglass product such as strength, stiffness, and recovery from compression. The cured glass fibers are then used to make a variety of fiberglass products, such as fiberglass insulation.

In the normal process of making fiberglass insulation, a binder is applied in a way to ensure that the anti-microbial is evenly distributed in the fiberglass product and provide a uniform hostile environment to mold or mildew grow throughout the entire product. The reasons for the even distribution are cost effectiveness as well as desired strength, stiffness, and durability of the fiberglass product.

Typical binders used in the fiberglass manufacturing process include polyacrylic acid and phenolic based binders. These binders include ingredients such as acrylic acid residues, glycerol, triethanol amine, lignin, pH modifiers, oil emulsions, as well as active and latent catalysts. In order to add any anti-microbials to the binder solution, the anti-microbial must be soluble or well dispersed in this binder so that it will not clog filters, spray tips or coat the inside of pipes, or storage tanks in the process of making fiberglass insulation. The anti-microbial cannot chemically or physically interfere with the curing process or affect the desired properties of the fiberglass insulation such as strength, stiffness, or recovery from compression. For example, if the anti-microbial would interfere with curing, the resulting product could be weak, limp, and have no insulation properties. Thus, each anti-microbial should not react with any of the ingredients within the binder solution, or react to a very minimal degree.

To inhibit the growth of these unwanted microorganisms, an anti-microbial is added to the binder composition and before the curing process. By adding the anti-microbial in-line in the manufacturing process, no additional processing steps or substantial capital investment are needed. Furthermore, because the anti-microbial is applied directly to the glass fibers with the binder, the anti-microbial is distributed along the length of the glass fiber. As a result, the anti-microbial is uniformly distributed throughout the fiberglass product, as opposed to being applied to only the surface of the product with a spray-on anti-microbial. This is especially useful in situations where an internal portion of the fiberglass product can be exposed to moisture and potential bacterial growth, such as with fiberglass insulation. Optionally, more than one anti-microbial can be added to the binder composition at one time.

A lower density fiberglass product, which has more open spaces, can benefit from the addition of an antibacterial to the binder during the fiberglass manufacturing process. In typical low-density residential insulation, unlike duct liner insulation, all of the surfaces can come into contact with contaminates such as water, dust, and dirt, which may be introduced during construction, a roof leak, or a flood. Because of the low density of the fiberglass product, contaminants have greater access to the center sections of the insulation, which could result in mold growth starting from within the fiberglass product. Thus, to destroy or prevent any mold growth within the fiberglass product, the entire fiberglass product can be treated with an anti-microbial according to the present invention.

Anti-microbials inhibit the growth of bacteria or fungi by acting on the cell wall or upon cell proteins, such as by attacking disulfide bonds. In order for the anti-microbial to be effective in a binder composition, it is necessary that it be compatible with the components of the binder and be uniformly dispersible in the binder composition. Examples of anti-microbials suitable for use with a polyacrylic acid based binder or a phenolic based binder include, but are not limited to, zinc 2-pyrimidinethiol-1-oxide, commonly known as Zinc Omadine®, which may be represented by the formula

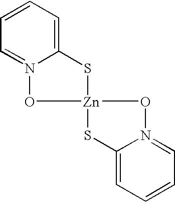

(CAS #13463-41-7); 1-[2-(3,5-Dichloro-phenyl)-4-propyl-[1,3]dioxolan-2-ylmethyl]-1H-[1,2,4]triazole, commonly referred to as Propiconazol® which may be represented by formula

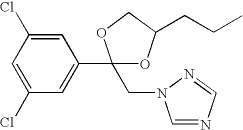

(CAS#60207-90-1); 4,5-Dichloro-2-octyl-isothiazolidin-3-one (DCOIT) which can be represented by the formula

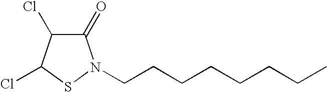

(CAS#64359-81-5); 2-Octyl-isothiazolidin-3-one (OIT)which may be represented by the following formula

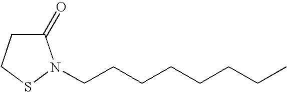

(CAS#26530-20-1); 5-Chloro-2-(2,4-dichloro-phenoxy)-phenol, commonly referred to as Tricolosan®, can be represented by the following formula

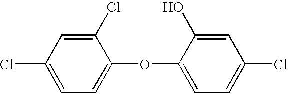

(CAS#3380-34-5); 2-Thiazol-4-yl-1H-benzoimidazole (Thiabendazole) which can be represented by the formula

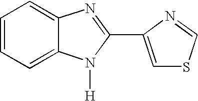

(CAS#148-79-8); 1-(4-Chloro-phenyl)-4,4-dimethyl-3-[1,2,4]triazol-4-ylmethyl-pentan-3-ol, commonly referred to as Tebuconazole®, which can be represented by the formula

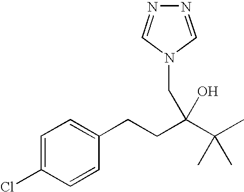

(CAS#107534-96-3); 10, 10′ Oxybisphenoxarsine (OBPA) which may be represented by the following formula

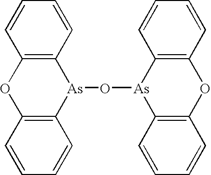

(CAS#58-36-6); and 1-(Diiodo-methanesulfonyl)-4-methyl-benzene, which can be represented by the formula

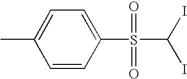

(CAS#20018-09-1), or mixtures thereof.

The amount of anti-microbial added to the binder is an amount sufficient to inhibit the growth of unwanted microorganisms including bacteria, fungi, and mold, and will vary depending on the specific anti-microbial utilized. Preferably, one or more suitable anti-microbials are incorporated in the binder in an amount of from 0.4-5% by weight based on the binder, and even more preferably from 0.1-3 percent.

Having generally described this invention, a further understanding can be obtained by reference to certain specific examples illustrated below which are provided for purposes of illustration only and are not intended to be all inclusive or limiting unless otherwise specified.

### EXAMPLE 1

### Preparation of Phenolic Binder Solution

An aqueous solution of trimethylolphenol (42% wt.) is obtained directly from the supplier and kept refrigerated until use. This aqueous solution of trimethylophenol (98.76 grams) is placed in a 1 L beaker. To this an aqueous solution of urea (50% wt., 49.77 grams) is added which is stirred and allowed to stand for a time period of 12 hours at room temperature. This phenolic/premix mixture is then stirred while room temperature water (727 grams) is added. To this mixture, a proprietary aqueous amino silane solution (2% wt., 3.34 grams) is added drop wise and allowed to stir for 3 minutes. To this mixture, an aqueous solution of ammonium sulfate (30% wt., 7.80 grams) is added slowly and allowed to stir for 3 minutes. To this mixture, a proprietary oil emulsion (30% wt., 13.37 grams) is added slowly and allowed to stir for 3 minutes. The resulting solution (900 grams) is referred as phenolic binder solution.

### EXAMPLE 2

### Preparation of Poly(acrylic acid) Binder Solution

A solution of poly(acrylic acid) with a small amount of sodium hypophosphate (47% wt solids) is obtained directly from our supplier. This solution (520 grams) is added to a 1 L beaker. To this solution, water (353 grams) is added and allowed to stir for 1 minute. To this mixture glycerol (25 grams) is added and allowed to stir for 1 minute. To this mixture, a proprietary aqueous amino silane solution (2% wt., 3.34 grams) is added drop wise and allowed to stir for 3 minutes. To this mixture, a proprietary oil emulsion (30% wt., 13.37 grams) is added slowly and allowed to stir for 3 minutes. The resulting solution (900 grams) is referred as poly(acrylic acid) binder solution.

### EXAMPLE 3

### The Preparation of Glass Fiber Sheets

The glass test sheets are made by a wet laying process. First water (5 liters) is added to a 10 liter stainless steel pot. To this water, a surfactant Schercopol DS140 (8 drops) is added. An air powered overhead stirrer with a turbine mixing head is lowered in the pot and set for a slow speed (approx. 200 RPM) as to stir but not produce any soap foam. To this stirring mixture, wet chop glass fibers (8 grams) are added and allowed to stir for 5 minutes. In a 12×12×12 inch 40 liter Williams standard pulp testing apparatus a.k.a. a deckle box, a screen catch is placed and the box closed. This is then filled with water (25 liters). To the water in the deckle box, a 0.5% wt. solution of polyacrylamide, NALCO 7768, (80 grams) is added and mixed until dissolved with a 10×10 inch plate hand agitator. After the glass fiber water has stirred for 5 minutes, a 0.5% wt. solution of polyacrylamide, NALCO 7768, (80 grams) is added and the stirring speed set to the highest setting (approx. 2000 RPM) and allowed to stir for 2 minutes. The glass fiber solution is then immediately dumped into the deckle box and stirred with the hand agitator for 10 strokes. At this point, the box drain is opened and the water drains with the screen catching the glass fibers. Upon complete draining, the box is opened and the screen with the glass sheet on top is removed. The excess water is then vacuumed off using a slot vacuum made in our lab for this purpose.

The binder solution being tested is added to a custom 5 inch in diameter, 12 inch in length graphite roll applicator with a variable speed motor. The roll is set to operate at 70 FPM. The binder is applied to the glass fiber through the screen from the bottom. This happens by applying the screen to the top of the applicator roll and moving across and opposite the roll's rotation. The sheet is rotated 90 degrees and the process repeated 3 times to ensure saturation of binder on the glass fiber mat. The excess binder is then vacuumed off. The glass mat is then transferred to a Mathis dryer by laying the screen with the glass mat downwards on the drying rack. This allows the screen to be pulled back leaving the glass mat on the rack. The rack is placed in the oven (400° F.) for a total of 3 minutes. The binder dries and cures in the oven. After 3 minutes, the glass mat usually forms a stiff sheet, which is removed from oven. This resulting glass fiber sheet is usually referred to as a fiberglass test sheet.

A section of the sheet is cut from the sample to determine the percent loss (% LOI) after heating to 1000° F. for 20 minutes. In cases of the both the phenolic and the poly(acrylic acid) binder solutions the % LOI is between 6-8% if the above procedure is followed closely.

### EXAMPLE 4

### The Addition of Zinc Omadine® to Phenolic Binder Solution

Zinc Omadine® is obtained from a number of sources as a water dispersion or emulsion at 40% wt active solids.

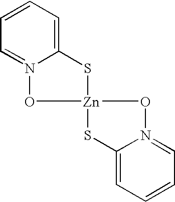

### Zinc 2-pyridine thiol-1-oxide (CAS#13463-41-7) Zinc Omadine®

In this process, for each concentration of Zinc Omadine® a batch of phenolic binder solution (900 grams) is made according to Example 1. The amount of Zinc Omadine® emulsion added to the binder solution is calculated upon the assumption that only 6% of anti-microbial adheres to the fiberglass test sheets. The following chart summarizes the amount of Zinc Omadine® added phenolic binder solution. For the desired concentration of anti-microbial in the units of parts per million (PPM) for the overall fiberglass test sheet, the corresponding amount of anti-microbial emulsion in grams was added to binder solution while maintaining vigorous stirring.

The treated binder solution is then used in the production of fiberglass test sheets as described in Example 3.

| Desired Concentration | Amount of Zinc | % anti-microbial |
|---|---|---|
| of anti-microbial in | Omadine 40% | emulsion in Binder |
| Test Sheet (PPM) | emulsion (grams) | Solids |
| 150 | 0.56 | 0.63 |
| 300 | 1.13 | 1.25 |
| 600 | 2.35 | 2.50 |
| 900 | 3.38 | 3.75 |

### EXAMPLE 5

### The Addition of Zinc Omadine® to Poly(acrylic acid) Binder Solution

Zinc Omadine® is obtained from a number of sources as a water dispersion or emulsion at 40% wt active solids.

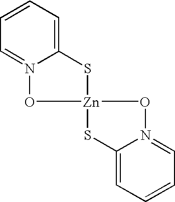

### Zinc-2-pyridine thiol-1-oxide (CAS#13463-41-7) Zinc Omadine®

In this process, for each concentration of Zinc Omadine® a batch of poly(acrylic acid) binder solution (900 grams) is made according to Example 2. The amount of Zinc Omadine® emulsion added to the binder solution is calculated upon assumption that only 6% of anti-microbial adheres to the fiberglass test sheets. The following chart summarizes the amount of Zinc Omadine® added poly(acrylic acid) binder solution. For the desired concentration of anti-microbial in the units of parts per million (PPM) for the overall fiberglass test sheet, the corresponding amount of anti-microbial emulsion in grams was added to binder solution while maintaining vigorous stirring.

| Desired Concentration | Amount of Zinc | % anti-microbial |
|---|---|---|
| of anti-microbial in | Omadine 40% | emulsion in Binder |
| Test Sheet (PPM) | emulsion (grams) | Solids |
| 150 | 0.56 | 0.63 |
| 300 | 1.13 | 1.25 |
| 600 | 2.25 | 2.50 |
| 900 | 3.38 | 3.75 |

The treated binder solution is then used in the production of fiberglass test sheets as described in Example 3.

### EXAMPLE 6

### The Addition of Propiconazole® to Phenolic Binder Solution

Propiconazol®(1-[2-(3,5-Dichloro-phenyl)-4-propyl-[1,3]dioxolan-2-ylmethyl]-1H-[1,2,4,]triazole) is obtained from a number of sources as a water dispersion or emulsion between 26% and 50% wt active solids. This example uses a sample containing 26% wt of active ingredient.

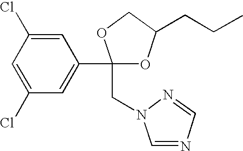

### 1-[2-(3,5-Dichloro-phenyl)-4-propyl-[1,3]dioxolan-2-ylmethyl]-1H-[1,2,4]triazole (CAS#60207-90-1) Propiconazol®

In this process, for each concentration of Propiconazole® a batch of phenolic binder solution (900 grams) is made according to Example 1. The amount of Propiconazole® emulsion added to the binder solution is calculated upon assumption that only 6% of anti-microbial adheres to the fiberglass test sheets. The following chart summarizes the amount of Propiconazole® added phenolic binder solution. For the desired concentration of anti-microbial in the units of parts per million (PPM) for the overall fiberglass test sheet, the corresponding amount of anti-microbial emulsion in grams was added to binder solution while maintaining vigorous stirring.

| Desired Concentration | Amount of | % anti-microbial |
|---|---|---|
| of anti-microbial in | Propiconazole ® 26% | emulsion in Binder |
| Test Sheet (PPM) | emulsion (grams) | Solids |
| 150 | 0.87 | 0.97 |
| 300 | 1.73 | 1.92 |
| 600 | 3.46 | 3.84 |
| 900 | 5.20 | 5.78 |

The treated binder solution is then used in the production of fiberglass test sheets as described in Example 3.

### EXAMPLE 7

### The Additional of Propiconazole® to Poly(acrylic acid) Binder Solution

Propiconazol® (1-[2-(3,5-Dichloro-phenyl)-4-propyl-[1,3]dioxolan-2-ylmethyl]-1H-[1,2,4]triazole) is obtained from a number of sources as a water dispersion or emulsion between 26% and 50% wt active solids. This example uses a sample containing 26% wt of active ingredient.

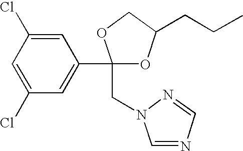

### 1-[2-(3,5-Dichloro-phenyl)-4-propyl-[1,3]dioxolan-2-ylmethyl]-1H-[1,2,4]triazole (CAS#60207-90-1) Propiconazol®

In this process, for each concentration of Propiconazole® a batch of poly(acrylic acid) binder solution (900 grams) is made according to Example 2. The amount of Propiconazole® emulsion added to the binder solution is calculated upon assumption that only 6% of anti-microbial adheres to the fiberglass test sheets. The following chart summarizes the amount of Propiconazole® added poly(acrylic acid) binder solution. For the desired concentration of anti-microbial in the units of parts per million (PPM) for the overall fiberglass test sheet, the corresponding amount of anti-microbial emulsion in grams was added to binder solution while maintaining vigorous stirring.

| Desired Concentration | Amount of | % anti-microbial |
|---|---|---|
| of anti-microbial in | Propiconazole ® 26% | emulsion in Binder |
| Test Sheet (PPM) | emulsion (grams) | Solids |
| 150 | 0.87 | 0.97 |
| 300 | 1.73 | 1.92 |
| 600 | 3.46 | 3.84 |
| 900 | 5.20 | 5.78 |

The treated binder solution is then used in the production of fiberglass test sheets as described in Example 3.

### EXAMPLE 8

### The Additional of 4,5-Dichloro-2-octyl-isothiazolidin-3-one to Phenolic Binder Solution

4,5-Dichloro-2-octyl-isothiazolidin-3-one (DCOIT) is obtained from a number of source as a water dispersion or emulsion with 40% wt active solids.

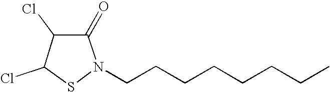

### 4,5-Dichloro-2-octyl-isothiazolidin-3-one (CAS#64359-81-5)

In this process, for each concentration of DCOIT a batch of phenolic binder solution (900 grams) is made according to Example 1. The amount of DCOIT emulsion added to the binder solution is calculated upon assumption that only 6% of anti-microbial adheres to the fiberglass test sheets. The following chart summarizes the amount of DCOIT added phenolic binder solution. For the desired concentration of anti-microbial in the units of parts per million (PPM) for the overall fiberglass test sheet, the corresponding amount of anti-microbial in grams was added to binder solution while maintaining vigorous stirring.

| Desired Concentration | | % anti-microbial |
|---|---|---|
| of anti-microbial in | Amount of DCOIT | emulsion in Binder |
| Test Sheet (PPM) | 40% emulsion (grams) | Solids |
| 150 | 0.56 | 0.63 |
| 300 | 1.13 | 1.25 |
| 600 | 2.25 | 2.50 |
| 900 | 3.38 | 3.75 |

The treated binder solution is then used in the production of fiberglass test sheets as described in Example 3.

### EXAMPLE 9

### The Addition of 4,5-Dichloro-2-octyl-isothiazolidin-3-one to Poly(acrylic acid) Binder Solution

4,5-Dichloro-2-octyl-isothiazolidin-3-one (DCOIT) is obtained from a number of sources as a water dispersion or emulsion with 40% wt active solids.

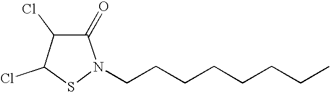

### 4,5-Dichloro-2-octyl-isothiazolidin-3-one (CAS#64359-81-5)

In the process, for each concentration of DCOIT a batch of poly(acrylic acid) binder solution (900 grams) is made according to Example 2. The amount of DCOIT emulsion added to the binder solution is calculated upon assumption that only 6% of anti-microbial adheres to the fiberglass test sheets. The following chart summarizes the amount of DCOIT added poly(acrylic acid) binder solution. For the desired concentration of anti-microbial in the units of parts per million (PPM) for the overall fiberglass test sheet, the corresponding amount of anti-microbial emulsion in grams was added to binder solution while maintaining vigorous stirring.

| Desired Concentration | | % anti-microbial |
|---|---|---|
| of anti-microbial in | Amount of DCOIT | emulsion in Binder |
| Test Sheet (PPM) | 40% emulsion (grams) | Solids |
| 150 | 0.56 | 0.63 |
| 300 | 1.13 | 1.25 |
| 600 | 2.25 | 2.50 |
| 900 | 3.38 | 3.75 |

The treated binder solution is then used in the production of fiberglass test sheets as described in Example 3.

### EXAMPLE 10

### The Additional of 2-Octyl-isothiazolidin-3-one to Phenolic Binder Solution

2-Octyl-isothiazolidin-3-one (OIT) is obtained from a number of sources as a water dispersion or emulsion at 40% wt active solids.

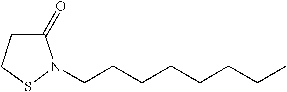

### 2-Octyl-isothiazolidin-3-one (CAS#26530-20-1)

In this process, for each concentration of OIT a batch of phenolic binder solution (900 grams) is made according to Example 1. The amount of OIT emulsion added to the binder solution is calculated upon assumption that only 6% of anti-microbial adheres to the fiberglass test sheets. The following chart summarizes the amount of OIT added phenolic binder solution. For the desired concentration of anti-microbial in the units of parts per million (PPM) for the overall fiberglass test sheet, the corresponding amount of anti-microbial emulsion in grams was added to binder solution while maintaining vigorous stirring.

| Desired Concentration | | % anti-microbial |
|---|---|---|
| of anti-microbial in | Amount of OIT 40% | emulsion in Binder |
| Test Sheet (PPM) | emulsion (grams) | Solids |
| 150 | 0.56 | 0.63 |
| 300 | 1.13 | 1.25 |
| 600 | 2.25 | 2.50 |
| 900 | 3.38 | 3.75 |

The treated binder solution is then used in the production of fiberglass test sheets as described in Example 3.

### EXAMPLE 11

### The Addition of 2-Octyl-isothiazolidin-3-one to Poly(acrylic acid) Binder Solution

2-Octyl-isothiazolidin-3-one (OIT) is obtained from a number of sources as a water dispersion or emulsion at 40% wt active solids.

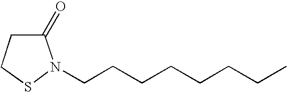

### 2-Octyl-isothiazolidin-3-one (CAS#26530-20-1)

In this process, for each concentration of OIT a batch of poly(acrylic acid) binder solution (900 grams) is made according to Example 2. The amount of OIT emulsion added to the binder solution is calculated upon assumption that only 6% of anti-microbial adheres to the fiberglass test sheets. The following chart summarizes the amount of OIT added phenolic binder solution. For the desired concentration of anti-microbial in the units of parts per million (PPM) for the overall fiberglass test sheet, the corresponding amount of anti-microbial emulsion in grams was added to binder solution while maintaining vigorous stirring.

| Desired Concentration | | % anti-microbial |
|---|---|---|
| of anti-microbial in | Amount of OIT 40% | emulsion in Binder |
| Test Sheet (PPM) | emulsion (grams) | Solids |
| 150 | 0.56 | 0.63 |
| 300 | 1.13 | 1.25 |
| 600 | 2.25 | 2.50 |
| 900 | 3.38 | 3.75 |

The treated binder solution is then used in the production of fiberglass test sheets as described in Example 3.

### EXAMPLE 12

### The Additional of Tricolosan® to Phenolic Binder Solution

Tricolosan®, 5-Chloro-2-(2,4-dichloro-phenoxy)-phenol, is obtained from a number of sources as a water dispersion or emulsion with 40% wt active solids.

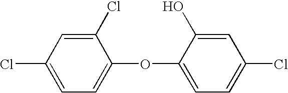

### 5-Chloro-2-(2,4-dichloro-phenoxy)-phenol (CAS#3380-34-5) Tricolosan®

In this process, for each concentration of Tricolosan® a batch of phenolic binder solution (900 grams) is made according to Example 1. The amount of Tricolosan® emulsion added to the binder solution is calculated upon assumption that only 6% of anti-microbial adheres to the fiberglass test sheets. The following chart summarizes the amount of Tricolosan® added phenolic binder solution. For the desired concentration of anti-microbial in the units of parts per million (PPM) for the overall fiberglass test sheet, the corresponding amount of anti-microbial emulsion in grams was added to binder solution while maintaining vigorous stirring.

| Desired Concentration | Amount of | % anti-microbial |
|---|---|---|
| of anti-microbial in | Tricolosan ® 40% | emulsion in Binder |
| Test Sheet (PPM) | emulsion (grams) | Solids |
| 150 | 0.56 | 0.63 |
| 300 | 1.13 | 1.25 |
| 600 | 2.25 | 2.55 |
| 900 | 3.38 | 3.75 |

The treated binder solution is then used in the production of fiberglass test sheets as described in Example 3.

### EXAMPLE 13

### The Addition of Tricolosan® to Poly(acrylic acid) Binder Solution

Tricolosan®, 5-Chloro-2-(2,4-dichloro-phenoxy)-phenol, is obtained from a number of sources as a water dispersion or emulsion with 40% wt active solids.

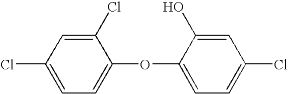

### 5-Chloro-2-(2,4-dichloro-phenoxy)-phenol (CAS#3380-34-5) Tricolosan®

In this process, for each concentration of Tricolosan® a batch of poly(acrylic acid) binder solution (900 grams) is made according to Example 2. The amount of Tricolosan® emulsion added to the binder solution is calculated upon assumption that only 6% of anti-microbial adheres to the fiberglass test sheets. The following chart summarizes the amount of Tricolosan® added poly(acrylic acid) binder solution. For the desired concentration of anti-microbial in the units of parts per million (PPM) for the overall fiberglass test sheet, the corresponding amount of anti-microbial emulsion in grams was added to binder solution while maintaining vigorous stirring.

| Desired Concentration | Amount of | |
|---|---|---|
| of anti-microbial in | Tricolosan ® 40% | % anti-microbial |
| Test Sheet (PPM) | emulsion (grams) | emulsion in Binder Solids |
| 150 | 0.56 | 0.63 |
| 300 | 1.13 | 1.25 |
| 600 | 2.25 | 2.50 |
| 900 | 3.38 | 3.75 |

The treated binder solution is then used in the production of fiberglass test sheets as described Example 3.

### EXAMPLE 14

### The Additional of Thiabendazole to Phenolic Binder Solution

Thiabendazole, 2-Thiazol-4-yl-1H-benzoimidazole, is obtained from a number of sources as a water dispersion or emulsion with 40% wt active solids.

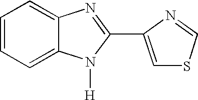

### 2-Thiazol-4-yl-1H-benzoimidazole (CAS#148-79-8) Thiabendazole

In this process, for each concentration of thiabendazole a batch of phenolic binder solution (900 grams) is made according to Example 1. The amount of thiabendazole emulsion added to the binder solution is calculated upon assumption that only 6% of anti-microbial adheres to the fiberglass test sheets. The following chart summarizes the amount of thiabendazole added phenolic binder solution. For the desired concentration of anti-microbial in the units of part per million (PPM) for the overall fiberglass test sheet, the corresponding amount of anti-microbial emulsion in grams was added to binder solution while maintaining vigorous stirring.

| Desired Concentration | Amount of | |
|---|---|---|
| of anti-microbial in | Thiabendazole 40% | % anti-microbial |
| Test Sheet (PPM) | emulsion (grams) | emulsion in Binder Solids |
| 150 | 0.56 | 0.63 |
| 300 | 1.13 | 1.25 |
| 600 | 2.25 | 2.50 |
| 900 | 3.38 | 3.75 |

The treated binder solution is then used in the production of fiberglass test sheets as described in Example 3.

### EXAMPLE 15

### The Additional of Thiabendazole to Poly(acrylic acid) Binder Solution

Thiabendazole, 2-Thiazol-4-yl-1H-benzoimidazole, is obtained from a number of sources as a water dispersion or emulsion with 40% wt active solids.

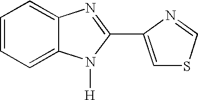

### 2-Thiazol-4-yl-1H-benzoimidazole (CAS#148-79-8) Thiabendazole

In this process, for each concentration of thiabendazole a batch of poly(acrylic acid) binder solution (900 grams) is made according to Example 2. The amount of thiabendazole emulsion added to the binder solution is calculated upon assumption that only 6% of anti-microbial adheres to the fiberglass test sheets. The following chart summarizes the amount of thiabendazole added phenolic binder solution. For the desired concentration of anti-microbial in the units of parts per million (PPM) for the overall fiberglass test sheet, the corresponding amount of anti-microbial emulsion in grams was added to binder solution while maintaining vigorous stirring.

| Desired Concentration | Amount of | |
|---|---|---|
| of anti-microbial in | Thiabendazole 40% | % anti-microbial |
| Test Sheet (PPM) | emulsion (grams) | emulsion in Binder Solids |
| 150 | 0.56 | 0.63 |
| 300 | 1.13 | 1.25 |
| 600 | 2.25 | 2.50 |
| 900 | 3.38 | 3.75 |

The treated binder solution is then used in the production of fiberglass test sheets as described in Example 3.

### EXAMPLE 16

### The Addition of Tebuconazole® to Phenolic Binder Solution

Tebuconazole®, 1-(4-Chloro-phenyl)-4,4-dimethyl-3-[1,2,4]triazol-4-ylmethyl-pentan-3-ol, is obtained from a number of sources as a water dispersion or emulsion with 40% wt active solids.

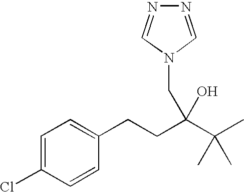

### 1-(4-Chloro-phenyl)-4,4-dimethyl-3-[ 1,2,4]triazol-4-ylmethyl-pentan-3-ol (CAS#107534-96-3) Tebuconazole®

In this process, for each concentration of Tebuconazole® a batch of phenolic binder solution (900 grams) is made according to Example 1. The amount of Tebuconazole® emulsion added to the binder solution is calculated upon assumption that only 6% of anti-microbial adheres to the fiberglass test sheets. The following chart summarizes the amount of Tebuconazole® added phenolic binder solution. For the desired concentration of anti-microbial in the units of parts per million (PPM) for the overall fiberglass test sheet, the corresponding amount of anti-microbial emulsion in grams was added to binder solution while maintaining vigorous stirring.

| Desired Concentration | Amount of | % anti-microbial |
|---|---|---|
| of anti-microbial in | Tebuconazole ® 40% | emulsion |
| Test Sheet (PPM) | emulsion (grams) | in Binder Solids |
| 150 | 0.56 | 0.63 |
| 300 | 1.13 | 1.25 |
| 600 | 2.25 | 2.50 |
| 900 | 3.38 | 3.75 |

The treated binder solution is then used in the production of fiberglass test sheets as described in Example 3.

### EXAMPLE 17

### The Additional of Tebuconazole® to Poly(acrylic acid) Binder Solution

Tebuconazole®, 1-(4-Chloro-phenyl)-4,4-dimethyl-3-[1,2,4]triazol-4-ylmethyl-pentan-3-ol, is obtained from a number of sources as a water dispersion or emulsion with 40% wt active solids.

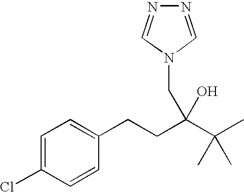

### 1-(4-Chloro-phenyl)-4,4-dimethyl-3-[1,2,4]triazol-4-ylmethyl-pentan-3-ol (CAS#107534-96-3) Tebuconazole®

In this process, for each concentration of Tebuconazole® a batch of poly(acrylic acid) binder solution (900 grams) is made according to Example 1. The amount of Tebuconazole® emulsion added to the binder solution is calculated upon assumption that only 6% of anti-microbial adheres to the fiberglass test sheets. The following chart summarizes the amount of Tebuconazole® added poly(acrylic acid) binder solution. For the desired concentration of anti-microbial in the units of parts per million (PPM) for the overall fiberglass test sheet, the corresponding amount of anti-microbial emulsion in grams was added to binder solution while maintaining vigorous stirring.

| Desired Concentration | Amount of | % anti-microbial |
|---|---|---|
| of anti-microbial in | Tebuconazole ® 40% | emulsion in Binder |
| Test Sheet (PPM) | emulsion (grams) | Solids |
| 150 | 0.56 | 0.63 |
| 300 | 1.13 | 1.25 |
| 600 | 2.25 | 2.50 |
| 900 | 3.38 | 3.75 |

The treated binder solution is then used in the production of fiberglass test sheets as described in Example 3.

### EXAMPLE 18

### The Addition of 10, 10′ Oxybisphenoxarsine to Phenolic Binder Solution

10, 10′ Oxybisphenoxarsine (OBPA) is obtained from a number of sources as a water dispersion or emulsion with 40% wt active solids.

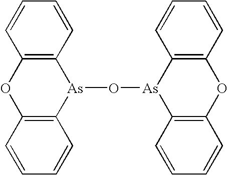

### 10, 10′ Oxybisphenoxarsine (CAS#58-36-6)

In this process, for each concentration of OBPA a batch of phenolic binder solution (900 grams) is made according to Example 1. The amount of OBPA emulsion added to the binder solution is calculated upon assumption that only 6% of anti-microbial adheres to the fiberglass test sheets. The following chart summarizes the amount of OBPA added phenolic binder solution. For the desired concentration of anti-microbial in the units of parts per million (PPM) for the overall fiberglass test sheet, the corresponding amount of anti-microbial emulsion in grams was added to binder solution while maintaining vigorous stirring.

| Desired Concentration | | % anti-microbial |
|---|---|---|
| of anti-microbial in | Amount of OBPA at | emulsion in Binder |
| Test Sheet (PPM) | 40% emulsion (grams) | Solids |
| 150 | 0.56 | 0.63 |
| 300 | 1.13 | 1.25 |
| 600 | 2.25 | 2.50 |
| 900 | 3.38 | 3.75 |

The treated binder solution is then used in the production of fiberglass test sheets as described in Example 3.

### EXAMPLE 19

The Addition of 10, 10′ Oxybisphenoxarsine to Poly(acrylic acid) Binder Solution

10, 10′ Oxybisphenoxarsine (OBPA) is obtained from a number of sources as a water dispersion or emulsion with 40% wt active solids.

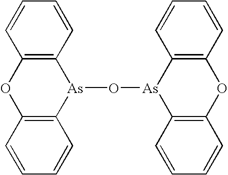

### 10, 10′ Oxybisphenoxarsine (CAS#58-36-6)

In this process, for each concentration of OBPA a batch of poly(acrylic acid) binder solution (900 grams) is made according to Example 2. The amount of OBPA emulsion added to the binder is calculated upon assumption that only 6% of anti-microbial adheres to the fiberglass test sheets. The following chart summarizes the amount of OBPA added poly(acrylic acid) binder solution. For the desired concentration of anti-microbial in the units of parts per million (PPM) for the overall fiberglass test sheet, the corresponding amount of anti-microbial emulsion in grams was added to binder solution while maintaining vigorous stirring.

| Desired Concentration | | % anti-microbial |
|---|---|---|
| of anti-microbial in | Amount of OBPA at | emulsion in Binder |
| Test Sheet (PPM) | 40% emulsion (grams) | Solids |
| 150 | 0.56 | 0.63 |
| 300 | 1.13 | 1.25 |
| 600 | 2.25 | 2.50 |
| 900 | 3.38 | 3.75 |

The treated binder solution is then used in the production of fiberglass test sheets as described in Example 3.

### EXAMPLE 19

### The Addition of 1-(Diiodo-methanesulfonyl)-4-methyl-benzene to Phenolic Binder Solution

1-(Diiodo-methanesulfonyl)-4-methyl-benzene is obtained from a number of sources as a water dispersion or emulsion with 40% wt active solids.

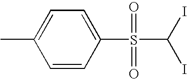

### 1-(Diiodo-methanesulfonyl)-4-methyl-benzene (CAS#20018-09-1)

In this process, for each concentration of 1-(Diiodo-methanesulfonyl)-4-methyl-benzene a batch of phenolic binder solution (900 grams) is made according to Example 1. The amount of 1-(Diiodo-methanesulfonyl)-4-methyl-benzene emulsion added to the binder solution is calculated upon assumption that only 6% of anti-microbial adheres to the fiberglass test sheets. The following chart summarizes the amount of 1-(Diiodo-methanesulfonyl)-4-methyl-benzene added phenolic binder solution. For the desired concentration of anti-microbial in the units of parts per million (PPM) for the overall fiberglass test sheet, the corresponding amount of anti-microbial emulsion in grams was added to binder solution while maintaining vigorous stirring.

| | Amount of 1-(Diiodo- | |
|---|---|---|
| Desired Concentration | methanesulfonyl)-4-methyl- | % anti-microbial |
| of anti-microbial in | benzene at 40% emulsion | emulsion in Binder |
| Test Sheet (PPM) | (grams) | Solids |
| 150 | 0.56 | 0.63 |
| 300 | 1.13 | 1.25 |
| 600 | 2.25 | 2.50 |
| 900 | 3.38 | 3.75 |

The treated binder solution is then used in the production of fiberglass test sheets as described in Example 3.

### EXAMPLE 20

### The Addition of 1-(Diiodo-methanesulfonyl)-4-methyl-benzene to Poly(acrylic acid) Binder Solution

1-(Diiodo-methanesulfonyl)-4-methyl-benzene is obtained from a number of sources as a water dispersion or emulsion with 40% wt active solids.

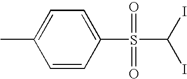

### 1-(Diiodo-methanesulfonyl)-4-methyl-benzene (CAS#20018-09-1)

In this process, for each concentration of 1-(Diiodo-methanesulfonyl)-4-methyl-benzene a batch of poly(acrylic acid) binder solution (900 grams) is made according to Example 2. The amount of 1-(Diiodo-methanesulfonyl)-4-methyl-benzene emulsion added to the binder solution is calculated upon assumption that only 6% of anti-microbial adheres to the fiberglass test sheets. The following chart summarizes the amount of 1-(Diiodo-methanesulfonyl)-4-methyl-benzene added poly(acrylic acid) binder solution. For the desired concentration of anti-microbial in the units of parts per million (PPM) for the overall fiberglass test sheet, the corresponding amount of anti-microbial emulsion in grams was added to binder solution while maintaining vigorous stirring.

| | Amount of 1-(Diiodo- | |
|---|---|---|
| Desired Concentration | methanesulfonyl)-4-methyl- | % anti-microbial |
| of anti-microbial in | benzene at 40% emulsion | emulsion in Binder |
| Test Sheet (PPM) | (grams) | Solids |
| 150 | 0.56 | 0.63 |
| 300 | 1.13 | 1.25 |
| 600 | 2.25 | 2.50 |
| 900 | 3.38 | 3.75 |

The treated binder solution is then used in the production of fiberglass test sheets as described in Example 3.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A method for inhibiting the growth of microorganisms in fiberglass products comprising the steps of:
adding a biocidally effective amount of at least one anti-microbial to a binder to form a binder composition;
applying said binder composition to distribute the anti-microbial along a length of a glass fiber;
curing said binder composition in an oven at a predetermined temperature;
forming said glass fibers into a fiberglass product.

2. The method of claim 1, wherein said binder is selected from the group consisting of a polyacrylic acid binder and a phenolic based binder.

3. The method of claim 2, wherein said anti-microbial is soluble or well-dispersed in said binder.

4. The method of claim 3, wherein said anti-microbial is evenly distributed throughout said fiberglass product.

5. The method of claim 4, wherein said anti-microbial is selected from the group consisting of zinc 2-pyrimidinethiol-1-oxide, 1-[2-(3,5-Dichloro-phenyl)-4-propyl-[1,3]dioxolan-2-ylmethyl]-1H-[1,2,4]triazole, 4,5-Dichloro-2-octyl-isothiazolidin-3-one, 2-Octyl-isothiazolidin-3-one, 5-Chloro-2-(2,4-dichloro-phenoxy)-phenol, 2-Thiazol-4-yl-1H-benzoimidazole, 1-(4-Chloro-phenyl)-4,4-dimethyl-3-[1,2,4]triazol-4-ylmethyl-pentan-3-ol, 10, 10′ Oxybisphenoxarsine, 1-(Diiodo-methanesulfonyl)-4-methyl-benzene and mixtures thereof.

6. The method of claim 4, wherein said biocidally effective amount is from 0.4-5% by weight based on said binder.

7. The method of claim 6, wherein said biocidally effective amount is from 0.1-3%.

8. The method of claim 6, wherein said anti-microbial is non-reactive with said binder.

9. The method of claim 8, wherein said fiberglass product is low-density fiberglass insulation.

10. The method of claim 8, wherein said predetermined temperature is an amount of from 350-550° F.

11. A fiberglass product comprising:
a plurality of glass fibers formed into said fiberglass product, each said glass fiber having an external surface;
a binder solution applied to the external surface of each said glass fiber and cured thereon; and
an anti-microbial incorporated into said binder solution before being applied to said glass fibers to provide a uniform distribution of said anti-microbial throughout said fiberglass product.

12. The fiberglass product of claim 11, wherein said binder solution includes a member selected from the group consisting of a polyacrylic acid binder and a phenolic based binder.

13. The fiberglass product of claim 12, wherein said anti-microbial is soluble or well-dispersed in said binder solution and non-reactive with said binder solution.

14. The fiberglass product of claim 13, wherein said anti-microbial is selected from the group consisting of zinc 2-pyrimidinethiol-1-oxide, 1-[2-(3,5-Dichloro-phenyl)-4-propyl-[1,3]dioxolan-2-ylmethyl]-1H-[1,2,4]triazole, 4,5-Dichloro-2-octyl-isothiazolidin-3-one, 2-Octyl-isothiazolidin-3-one, 5-Chloro-2-(2,4-dichloro-phenoxy)-phenol, 2-Thiazol-4-yl-1H-benzoimidazole, 1-(4-Chloro-phenyl)-4,4-dimethyl-3-[1,2,4]triazol-4-ylmethyl-pentan-3-ol, 10, 10′ Oxybisphenoxarsine, 1-(Diiodo-methanesulfonyl)-4-methyl-benzene and mixtures thereof.

15. The fiberglass product of claim 13, wherein said fiberglass product is low-density fiberglass insulation.

16. The fiberglass product of claim 15, wherein said binder solution is cured to the external surface of each said glass fiber at a temperature of from 350-550° F.

17. A method of inhibiting the growth of microorganisms in fiberglass products formed from glass fibers having a binder solution cured on an external surface of said glass fibers, comprising the steps of:
adding a biocidally effective amount of at least one anti-microbial to the external surface of said glass fibers before said binder solution is cured.

18. The method of claim 17, wherein said anti-microbial is added to said binder solution prior to being applied to the external surface of said glass fibers.

19. The method of claim 20, wherein said anti-microbial is evenly distributed throughout said fiberglass product.

20. The method of claim 19, wherein said anti-microbial is soluble or well-dispersed in said binder.

21. The method of claim 20, wherein said anti-microbial is non-reactive with said binder.

22. The method of claim 21, wherein said anti-microbial is selected from the group consisting of zinc 2-pyrimidinethiol-1-oxide, 1-[2-(3,5-Dichloro-phenyl)-4-propyl-[1,3]dioxolan-2-ylmethyl]-1H-[1,2,4]triazole, 4,5-Dichloro-2-octyl-isothiazolidin-3-one, 2-Octyl-isothiazolidin-3-one, 5-Chloro-2-(2,4-dichloro-phenoxy)-phenol, 2-Thiazol-4-yl-1H-benzoimidazole, 1-(4-Chloro-phenyl)-4,4-dimethyl-3-[1,2,4]triazol-4-ylmethyl-pentan-3-ol, 10, 10′ Oxybisphenoxarsine, 1-(Diiodo-methanesulfonyl)-4-methyl-benzene and mixtures thereof.

23. The method of claim 21, wherein said binder solution includes a member selected from the group consisting of a polyacrylic acid binder and a phenolic based binder.

24. The method of claim 23, wherein said biocidally effective amount is from 0.4-5% by weight based on said binder.

25. The method of claim 24, wherein said biocidally effective amount is from 0.1-3%.

26. The method of claim 21, wherein said fiberglass product is low-density fiberglass insulation.
